(19) United States
(12) Patent Application Publication
(10) Pub. No.: US 2008/0008554 A1
(43) Pub. Date: Jan. 10, 2008

(54) Self-drilling wall anchor device

(76) Inventor: Chien-Ming Lu, Taichung (TW)

Correspondence Address: CHARLES E. BAXLEY, ESQ., 90 JOHN STREET, THIRD FLOOR, NEW YORK, NY, 10038, US

(21) Appl. No.: 11/901,858

(22) Filed: Sep. 19, 2007

Related U.S. Application Data
(63) Continuation-in-part of application No. 11/448,325, filed on Jun. 7, 2006.

(51) Int. Cl. F16B 13/04

(52) U.S. Cl. 411/29

(57) ABSTRACT

A self-drilling wall anchor device has a central bolt, an outer sleeve and a drilling head. The central bolt has a bolt body, a head, a connection portion and an engaging portion. The outer sleeve is mounted around the bolt body of the central bolt and has a flange, a second thread, a compressed head and a deformable portion. The compressed head is formed on the distal end of the outer sleeve and has a through hole. The through hole is defined through the compressed head and engages with the engaging portion on the central bolt.

The present invention is a continuation-in-part application of application Ser. No. 11/448,325, filed on Jun. 7, 2006.

### BACKGROUND OF THE INVENTION

1. Field of the Invention

The present invention relates to a wall anchor device, and more particularly to a wall anchor device that can be securely attached to a wall in a single rotation process.

2. Description of Related Art

To hand an object on a wall, such as a plaster of Paris cast or a plastic, wooden or concrete wall, a nail is hammered into the wall for supporting the object. However, the weight of the hung object will apply a large torque to the inserted portion of the nail to cause the hole in the wall for holding the nail to be enlarged. Thus, the nail with the object easily falls from the wall, and the nail cannot support a heavy load.

To overcome the shortcomings, the present invention tends to provide a wall anchor to mitigate or obviate the aforementioned problems.

### SUMMARY OF THE INVENTION

The main objective of the invention is to provide a self-drilling wall anchor device that can be securely attached to a wall in a single rotation process and is convenient in use and assembling. The self-drilling wall anchor device has a central bolt, an outer sleeve and a drilling head. The central bolt has a bolt body, a head, a connection portion and an engaging portion. The bolt body has a proximal end, a distal end and a first thread formed around the bolt body and having a diameter. The head is formed on the proximal end of the bolt body. The connection portion is formed on the distal end of the bolt body and has a diameter. The engaging portion is formed between the bolt body and the connecting portion. The outer sleeve is mounted around the bolt body of the central bolt and has an outer diameter, a proximal end, a distal end, a flange, a second thread, a compressed head and a deformable portion. The flange is radially formed on and extends from the proximal end of the outer sleeve. The second thread is formed around the outer sleeve near the flange. The compressed head is formed on the distal end of the outer sleeve and has a proximal end, a distal end and a through hole. The proximal end is formed on the distal end of the outer sleeve. The through hole is defined through the compressed head and engages with the engaging portion on the central bolt. The deformable portion is mounted between the compressed head and the second thread and has multiple slots longitudinally defined in the deformable portion. The drilling head is attached to and rotated with the connection portion of the central bolt and has multiple blades having a diameter larger than the outer diameter of the outer sleeve.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of a first embodiment of a self-drilling wall anchor in accordance with the present invention;

FIG. 2 is an exploded perspective view of the wall anchor in FIG. 1;

FIG. 3 is a side plan view in partial section of the wall anchor in FIG. 1;

FIG. 4 is an enlarged perspective view in partial section of the wall anchor in FIG. 1;

FIG. 5 is an enlarged cross sectional side plan view of the compressed head of the wall anchor in FIG. 1;

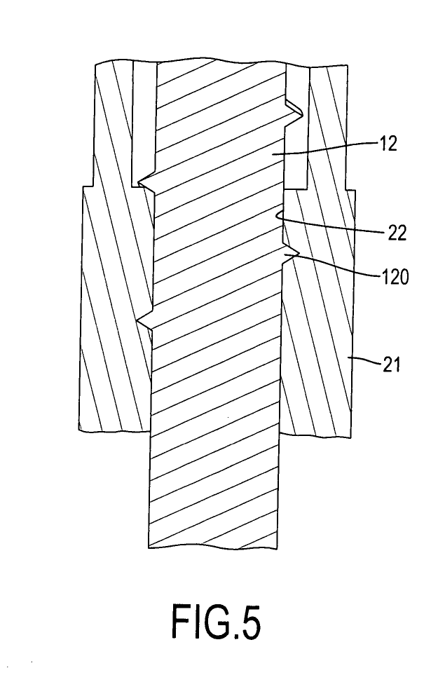

FIG. 6 is an exploded perspective view of a second embodiment of a self-drilling wall anchor in accordance with the present invention;

FIG. 7 is an exploded perspective view of a third embodiment of a self-drilling wall anchor in accordance with the present invention; and

FIG. 8 is an exploded perspective view of a fourth embodiment of a self-drilling wall anchor in accordance with the present invention.

### DETAILED DESCRIPTION OF PREFERRED EMBODIMENT

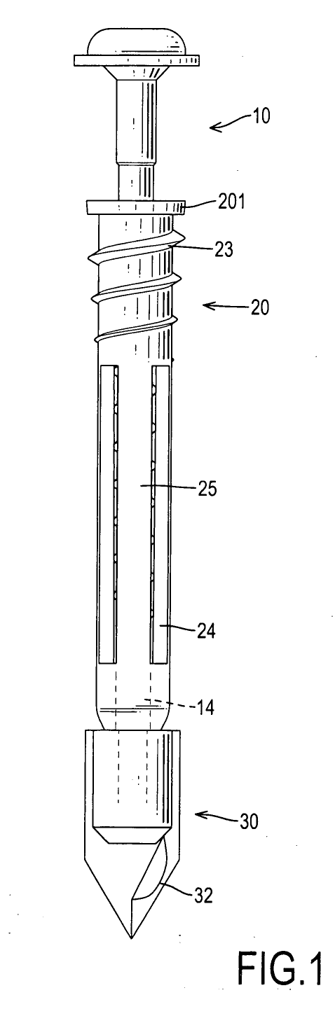

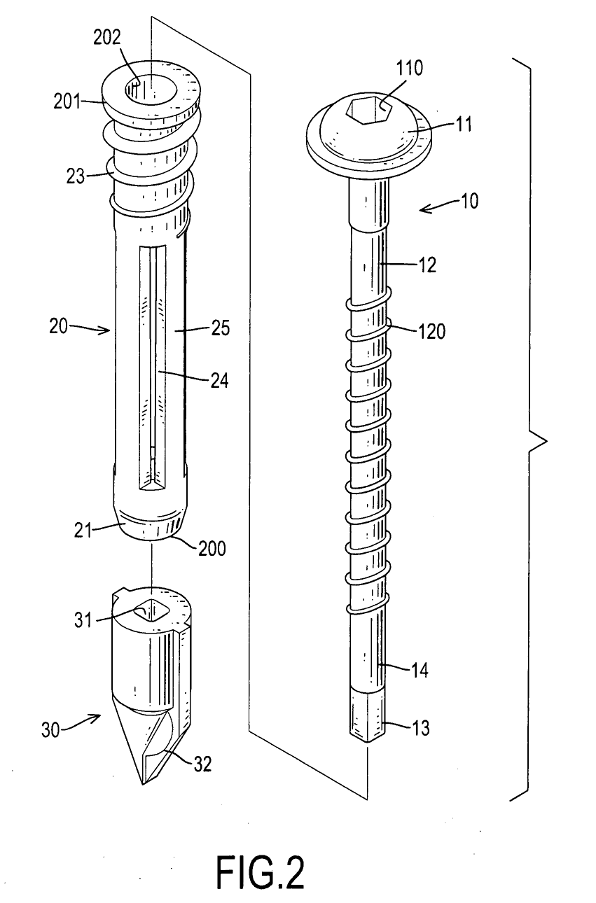

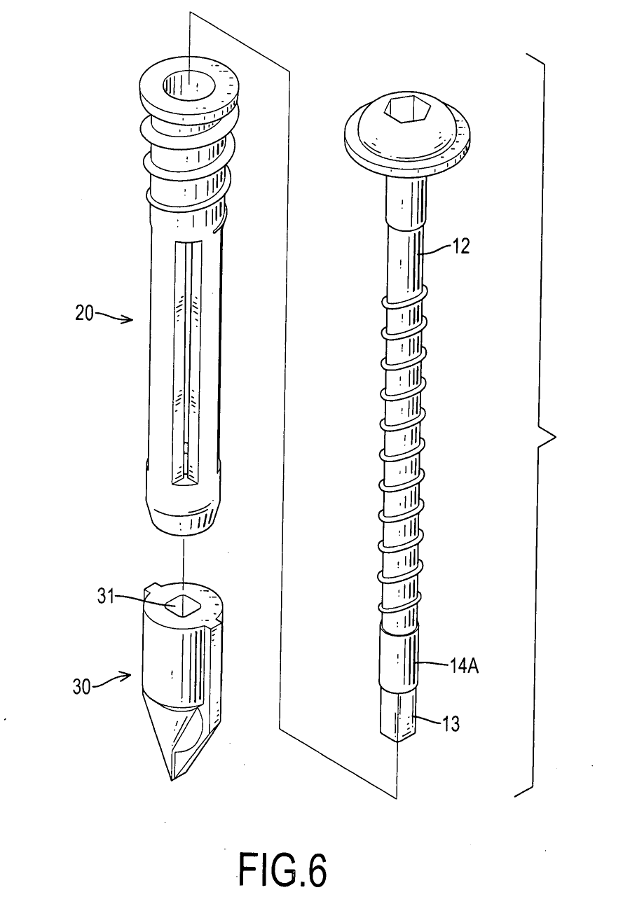

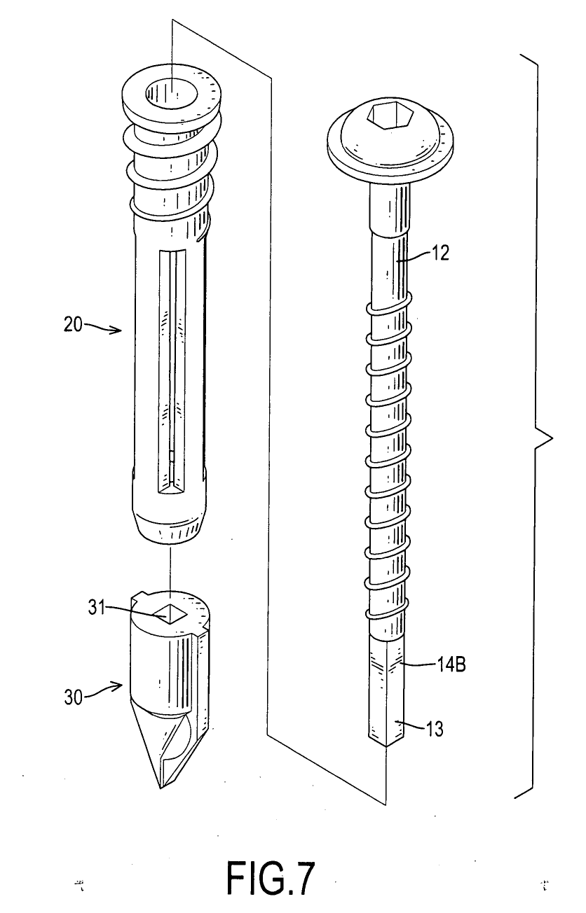

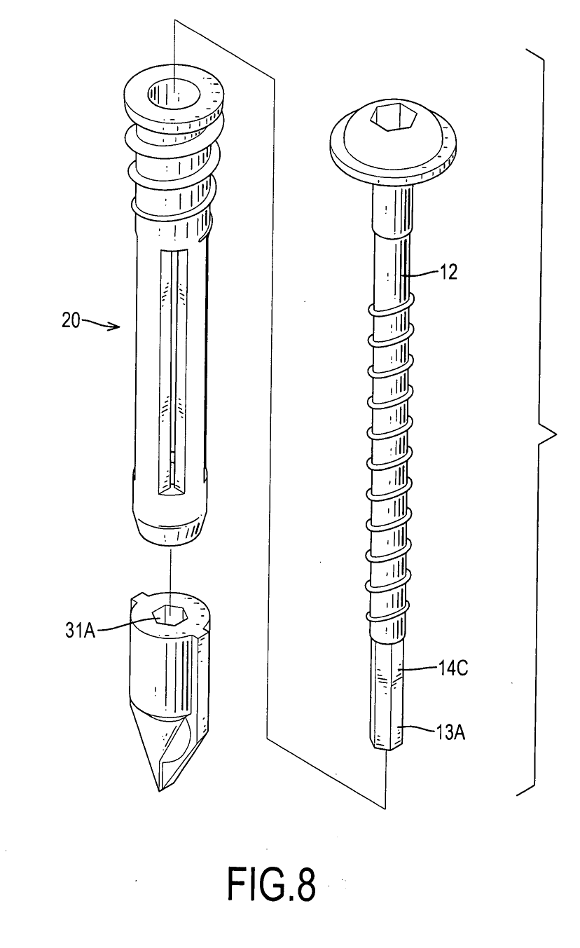

With reference to FIGS. 1 and 2, a self-drilling wall anchor device in accordance with the present invention comprising a central bolt (10), an outer sleeve (20) and a drilling head (30). The central bolt (10) comprises a bolt body (12), a head (11), a connection portion (13) and an engaging portion (14). The bolt body (12) has a proximal end, a distal end and a first thread (120) formed around the bolt body (12) and having a diameter. The first thread (120) may be a self-drilling thread and has a diameter gradually enlarged from the distal end to the proximal end of the central bolt (12). The head (11) is formed on the proximal end of the bolt body (12) and has a tool recess (110) defined in the head (11). The tool recess (110) may be square, hexagonal or crisscross to fit with different tools. The connection portion (13,13A) is formed on the distal end of the bolt body (10) and has a diameter and a polygonal cross section, such as a square cross section as shown in FIG. 7 or a hexagonal cross section as shown in FIG. 8. The engaging portion (14) is formed between the bolt body (12) and the connecting portion (13) and has a diameter. In a second embodiment as shown in FIG. 6, the diameter of the engaging portion (14A) is larger than that of the bolt body (12) and the connecting portion (13). Additionally, the engaging portion (14B,14C) has a polygonal cross section, such as a square cross section as shown in FIG. 7 or a hexagonal cross section as shown in FIG. 8 corresponding to that of the connecting portion (13,13A).

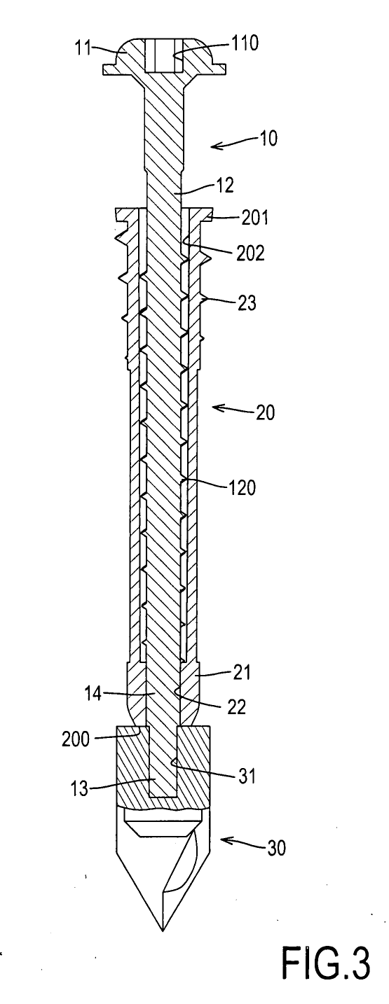

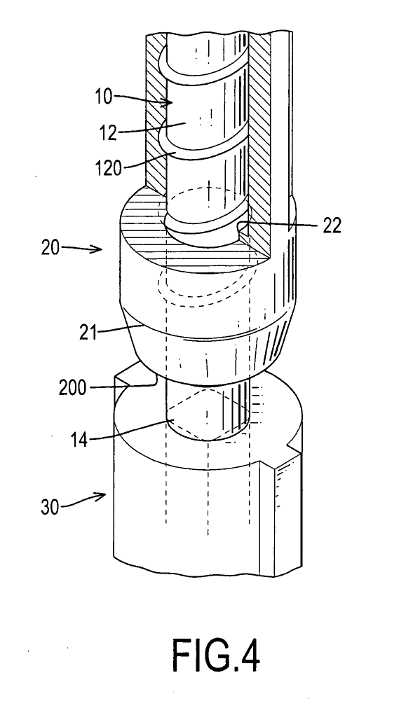

With further reference to FIGS. 3 and 4, the outer sleeve (20) is made of plastic material and is mounted around the bolt body (12) of the central bolt (10). The outer sleeve (20) has a diameter, a proximal end, a distal end, a central hole (202), a flange (201), a second thread (23), a compressed head (21) and a deformable portion (25). The central hole (202) is defined through the outer sleeve (20) and has a diameter larger than that of the first thread (120) on the central bolt (10) to hold the bolt body (12) inside. The flange (201) is radially formed on and extends from the proximal end of the outer sleeve (20). The second thread (23) is formed around the outer sleeve (20) near the flange (201). The second thread (23) has a diameter gradually decreased from an end near the flange (201) to the other end to form as a self-drilling thread. The compressed head (21) is formed on the distal end of the outer sleeve (20) and has a proximal end, a distal end and a through hole (22). The proximal end is formed on the distal end of the outer sleeve (20). The through hole (22) is defined through the compressed head (21), communicates with the central hole (202) of the outer sleeve (20) and engages with the engaging portion (14) on the central bolt (10). The through hole (22) has a diameter larger than that of the connection portion (13) of the central bolt (10) and smaller than that of the first thread (120) on the central bolt (10). When the engaging portion (14) on the central bolt (10) has a round cross section as shown in FIGS. 2 and 6, the through hole (22) has a diameter same as that of the engaging portion (14) and the inner surface of the through hole (22) contacts completely with the outer surface of the engaging portion (14).

The deformable portion (25) is mounted between the compressed head (21) and the second thread (23) and has multiple slots (24) longitudinally defined in the deformable portion (25) to make the deformable portion (25) be resilient for deformation.

The drilling head (30) is attached to and rotated with the connection portion (13) of the central bolt (10). The drilling head (30) and the connection portion (13) of the central bolt (10) are combined with each other in a multiple-facets manner. In other words, with reference to FIGS. 2 and 6 to 8, a square or hexagonal cavity (31,31A) is defined in the drilling head (30) to engage with a square or hexagonal cross sectional connection portion (13,13A). With the engagement of the cavity (31,31A) and the connecting portion (13,13A), the drilling head (30) is detachably connected and rotated with the central bolt (10). The drilling head (30) has multiple blades (32) having a diameter larger than the outer diameter of the outer sleeve (20).

In use, the outer sleeve (20) is rotated with the central bolt (10) and the second thread (23) on the outer sleeve (20) will be screwed into a hole previously defined in a wall. With the engagement between through hole (22) and the engaging portion (14), the combination between the outer sleeve (20) with the central bolt (10) is high to keep the outer sleeve (20) from rotating relative to the central bolt (10).

Additionally, with the multiple-facets combination between the cavity (31) in the drilling head (30) and the connecting portion (13) of the central bolt (10), the relative rotation between the drilling head (30) and the central bolt (10) is completely avoided. To apply glue between the cavity (31) and the connecting portion (13) is unnecessary, the process of and cost for assembling the wall anchor are simplified and reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A self-drilling wall anchor device comprising:
a central bolt comprising
a bolt body having a proximal end, a distal end and a first thread formed around the bolt body and having a diameter,
a head formed on the proximal end of the bolt body;
a connection portion formed on the distal end of the bolt body and having a diameter; and
an engaging portion formed between the bolt body and the connecting portion and having a diameter;
an outer sleeve mounted around the bolt body of the central bolt and comprising
an outer diameter;
a proximal end;
a distal end;
a flange radially formed on and extending from the proximal end of the outer sleeve;
a second thread formed around the outer sleeve near the flange;
a compressed head formed on the distal end of the outer sleeve and having
a proximal end formed on the distal end of the outer sleeve;
a distal end; and
a through hole defined through the compressed head and engaging with the engaging portion on the central bolt; and
a deformable portion mounted between the compressed head and the second thread and having multiple slots longitudinally defined in the deformable portion; and
a drilling head attached to and rotated with the connection portion of the central bolt and having multiple blades having a diameter larger than the outer diameter of the outer sleeve.

2. The wall anchor device as claimed in claim 1, wherein the diameter of the engaging portion is larger than that of the bolt body and the connecting portion; and
the through hole has a diameter same as that of the engaging portion.

3. The wall anchor device as claimed in claim 1, wherein the engaging portion has a square cross section.

4. The wall anchor device as claimed in claim 1, wherein the engaging portion has a hexagonal cross section.

5. The wall anchor device as claimed in claim 1, wherein the drilling head and the connection portion of the central bolt are combined with each other in a multiple-facets manner.

6. The wall anchor device as claimed in claim 1, wherein the drilling head has a cavity engaging with the connecting portion of the central bolt and having a square cross section; and
the connecting portion of the central bolt has a square cross section.

7. The wall anchor device as claimed in claim 3, wherein the drilling head has a cavity engaging with the connecting portion of the central bolt and having a square cross section; and
the connecting portion of the central bolt has a square cross section.

8. The wall anchor device as claimed in claim 1, wherein the drilling head has a cavity engaging with the connecting portion of the central bolt and having a hexagonal cross section; and
the connecting portion of the central bolt has a hexagonal cross section.

9. The wall anchor device as claimed in claim 4, wherein the drilling head has a cavity engaging with the connecting portion of the central bolt and having a hexagonal cross section; and
the connecting portion of the central bolt has a hexagonal cross section.
